(19) United States
(12) Patent Application Publication
(10) Pub. No.: US 2005/0175337 A1
(43) Pub. Date: Aug. 11, 2005

(54) Method for processing a color reversal photographic film

(76) Inventors: Didier J. Martin, Givry (FR); Olivier J. Poncelet, Chalon Sur Saone (FR); Danielle M. Wettling, Chatenoy le Royao (FR)

Correspondence Address: PATENT LEGAL STAFF;EASTMAN KODAK COMPANY, 343 STATE STREET, ROCHESTER, NY, 14650-2201, US

(21) Appl. No.: 10/496,533

(22) PCT Filed: Nov. 18, 2002
(86) PCT No.: PCT/EP02/12909

(30) Foreign Application Priority Data
Dec. 3, 2001 (FR) 0115562

(51) Int. Cl. G03D 5/00

(52) U.S. Cl. 396/611

(57) ABSTRACT

The present invention relates to a method for processing a color reversal photographic film that enables the amount of silver and tin (II) ions present in the washing water to be reduced, in order to obtain effluents that can be discharged to the drains and satisfy the regulations in force. The method according to the invention comprises the mixing with stirring of the washing water with a composite material comprising a polymer matrix in the form of an imogolite gel in fiber form comprising at least, on the fiber surface, an organic radical having an —SH function or an —S(—CH2)ₙ—S— radical, with n between 0 and 4; the settling of said mixture, and the recovery of a supernatant having greatly reduced quantities of silver and tin (II) ions, enabling direct discharge to the drains.

### FIELD OF THE INVENTION

The present invention relates to a method for processing a color reversal photographic film.

### BACKGROUND OF THE INVENTION

A conventional method for processing a reversal color film, comprises a chemical reversal step (or fogging exposure) between a black and white development step and a color development step. The chemical reversal step or the fogging step makes it possible to develop the silver halides which had not been initially exposed. Such a processing method for color reversal films is well known and described in detail in “Chimie et Physique Photographiques” Volume 2, P Glafkidès, 5th edition, Chapter XL, pages 947-967.

One example of such a processing method for a color reversal film is the Ektachrome E-6® processing described in detail on page 954 of Glafkidès above-mentioned book. During the Ektachrome E-6® photographic processing, the exposed photographic material is successively circulated through each of the following baths:
a) a black and white development bath,
b) a first washing bath,
c) a chemical reversal bath,
d) a color development bath,
e) a conditioning bath,
f) a bleaching bath,
f) a fixing bath,
h) one or more washing baths, and
i) a rinsing bath.
   These are followed by drying step.

During the circulation of the photographic material from tank to tank, significant amounts of chemical compounds are carried over from one tank to another either by the photographic material, or by the conveyor belts of the photographic processor. These chemical compounds accumulate in the processing baths, thus reducing their efficiency. The carry-over of these chemical compounds gets more significant as the processing of the photographic materials gets faster.

A method to minimize the carry-over of chemical compounds consists in replenishing the washing baths by the continuous addition of clean water in order to maintain a very low concentration of chemicals in these washing baths.

For example, it is known to place a first washing bath between the first black and white development bath and the chemical reversal bath. This first washing bath aims to interrupt the chemical reactions caused by the compounds of the first development bath and prevent the migration by carry-over from the first developer to the reversal bath, thus preventing deterioration of the quality of the image of the developed film. In Ektachrome E-6® standard processing, it is usual, for washing baths, to use a continuous water supply that can reach a flow rate of 7.5 liters per minute. Such a method results in considerable water consumption, which increases the cost of the processing. In addition, development laboratories must now comply with certain regulations that very clearly restrict water consumption per square meter of developed films.

Similarly, to limit the water consumption of color reversal photographic film processing mini-laboratories, it is known to maintain the water level in each washing bath by a counter-current from the downstream bath, and to discharge an equivalent volume of water by overflow into a tank, while maintaining a water supply for the final rinsing bath. The processing of exposed color reversal films in this type of development mini-laboratory (more commonly known as a minilab) comprises baths in the following order:
a) a black and white development bath,
b) a first washing bath, initially filled with clean water, whose water level is maintained by a counter-current from the reversal bath and where an equivalent volume of water is discharged by overflow,
c) a chemical reversal bath,
d) a color development bath,
e) a conditioning bath,
f) a bleaching bath,
f) a fixing bath,
h) at least two final washing baths whose water level is maintained by a counter-current from the rinsing bath placed downstream, and
i) a final rinsing bath supplied with water by an auxiliary source. The drying step is then carried out.

However, one of the problems encountered with this type of installation is the accumulation with time of organic and inorganic contaminants in the baths, especially in the washing baths. For example, because a counter-current from the reversal bath maintains the water level of the first washing bath, tin (II) is found in the first washing bath. Silver in ionic form is also found in the various washing baths. Therefore the washing baths cannot be discharged as such to the drains and require a suitable decontamination treatment.

Furthermore, the accumulation of certain contaminants results in harmful effects on the film development quality. For example, when the tin (II) content is greater than about 400 ppm in the first washing bath, an effect very harmful to the sensitometry of the developed films is observed. In order to prevent this problem, a color reversal film processing method is described in European Patent Application EP-A-1,132,771 in which waters from the first washing bath are collected and purified using a nanofiltration unit capable of providing a photographically useful permeate, weakly charged in tin (II) and silver ions, and recyclable in the washing baths of the processing. This method limits the water consumption of the washing baths and eliminates the problems of discharging chemical substances to the drains while maintaining good sensitometry of the developed films. However, the nanofiltration treatment generates a final retentate, containing all the contaminating ions removed in the nanofiltration, such as silver, iron, tin (II), thiosulfates, sulfates and halides. In addition, regular washing of the membrane used in the nanofiltration unit also generates effluents to be treated. These “ultimate” effluents from the final retentate and the washing of the nanofiltration membrane contain too many silver and tin (II) ions compared with the standards in force and cannot be discharged as such to the drains, which entails collecting them and finding other costly removal means.

### SUMMARY OF THE INVENTION

The present invention provides a photographic processing method that enables the quantity of silver and tin (II) ions present in the washing water to be reduced, in order to obtain effluents that can be discharged to the drains and satisfy the regulations in force. The present invention also provides a photographic processing method that enables the treatment of the ultimate effluents so that all the effluents from the color reversal processing method satisfy the regulations and can be discharged to the drains.

The present invention relates to a method for processing an exposed color reversal photographic film comprising the steps of circulating this exposed film successively in:
i) a black and white development bath,
ii) a first washing bath containing silver in ionic form,
iii) a reversal bath comprising tin (II) salts,
   wherein the level of water in the first washing bath is maintained by a counter-current from the reversal bath, a volume of water at least equal to that provided by the counter-current being discharged through an overflow, said method comprising the following steps:
a) collect the water from said overflow and the contents of said first washing bath, said water comprising silver and tin (II) ions,
b) put the collected water in a vessel equipped with stirring means and containing a composite material comprising a polymer matrix in the form of an imogolite gel in fiber form comprising at least on the fiber surface an organic radical having a function —SH or a radical —S(—CH2)ₙ—S—, with n between 0 and 4,
c) stir said composite material and the collected water to let them mix,
d) leave said mixture to settle in order to obtain a supernatant,
e) recover said supernatant.

The recovered supernatant contains silver and tin (II) ions in quantities less than the quantities of silver and tin (II) ions contained in the water collected in step (a).

The quantity of silver and tin (II) ions removed from the collected washing water depends especially on the duration of step c). The duration of stirring will therefore be long enough to obtain a supernatant comprising silver and tin (II) ions in quantities corresponding to the regulations, enabling the supernatant to be discharged directly to the drains or to be recycled.

Advantageously, the invention method, additionally comprising the circulation of the film in at least one final washing bath, also comprises a step f) consisting in collecting the contents of said final washing bath and mixing it, before step (b), with the water from said overflow and the contents of said first washing bath collected in step (a).

In an especially advantageous embodiment, the invention method can be combined with a processing method also comprising a step g) carried out before step b), said step g) consisting in circulating the water collected in step (a) and/or step (f) through a nanofiltration unit to give on the one hand a permeate which can be used photographically, and a retentate on the other hand, said retentate being collected and used to carry out step (b). Such a processing method using a nanofiltration unit is described in European Patent Application EP-A-1,132,771. In this case, one can plan that, when the nanofiltration membrane used in the nanofiltration unit is washed, the water from washing the membrane is collected and added to the washing water collected in step a) and/or in step f) to produce an “ultimate” effluent. Thus, in this preferred embodiment, the invention processing method enables on the one hand a recyclable permeate to be obtained and on the other hand, the ultimate effluent to be treated so that it can be discharged directly to the drains. Thus no more effluent remains to be collected and treated separately.

### BRIEF DESCRIPTION OF THE DRAWINGS

FIG. 1 represents schematically a preferred embodiment of the processing method according to the present invention.

### DETAILED DESCRIPTION OF THE INVENTION

The composite material used in the present invention and its preparation process are described in U.S. Pat. No. 6,179,898 of the same applicant. This process comprises the hydrolysis of an alkylalkoxysilane of formula RSiR¹ₓ(OR²)₃₋ₓ wherein R is an alkyl group including an SH or —S(—CH₂)ₙ—S— function with n between 0 and 4, and R¹ and R² are independently a methyl or ethyl group, x is 0 or 1, in the presence of an inorganic aluminosilicate polymer comprising active hydroxyl groups on its surface. “Active hydroxyl groups” are groups capable of reacting with alkylalkoxysilane. The aluminosilicate polymer is preferably imogolite. Imogolite exists in impure form in the natural state; it was described for the first time by Wada in J. Soil Sci. 1979, 30(2), 347-355. inogolite can be synthesized with various degrees of purity using different methods. A method for obtaining an imogolite gel with a high degree of purity is described in the U.S. Pat. No. 5,888,711.

The alkylalkoxysilanes can be mercaptoalkylalkoxysilanes of formula HS—(CH₂)ₘ—SiR¹ₓ(OR²)₃₋ₓ wherein m is at least 1, R¹, R² and x being as defined above. Preferably, m is from 1 to 4. For example, they include 3-mercaptopropyltrimethoxysilane, 3-mercaptopropyltriethoxysilane, 3-mercaptopropylmethyl-dimethoxysilane, mercaptomethyl)methyldiethoxysilane, and (mercaptomethyl)dimethylethoxysilane. Alkylalkoxysilanes comprising an organic radical having an —S—S— function like for example Bis[3(triethoxysilyl)propyl]tetrasulfite can also be used. Alkylalkoxysilanes having a crown ether organic radical containing the —S—S— or —S(—CH₂)ₙ—S— function, n being from 1 to 4 can also be used.

When imogolite aluminosilicate is used as inorganic polymer, the alkylalkoxysilane hydrolysis is carried out at a pH greater than 7. Such a pH is obtained by the addition of a base to the reaction medium, for example NH₄OH, NaOH, or KOH. A pH greater than 7 enables the gelation of the imogolite.

In U.S. Pat. No. 6,179,898, a composite material having an —SH function or an —S(—CH2)ₙ—S— radical is used to reduce the ionic silver content present in the photographic washing baths, sulfur being effective for trapping the silver ions. In this method of the prior art, the composite material is placed in a permeable bag in contact with the washing bath to be treated in static mode, without any stirring. On the contrary, in the present invention, it was found surprisingly that placing the washing water in contact in dynamic mode with the composite material having an —SH function or an —S(—CH2)ₙ—S— radical, while maintaining stirring, by using a magnetic stirrer for example, significantly reduces the quantity of silver and tin (II) ions present in the washing water. The washing water thus treated satisfies the regulations for the maximum permitted concentrations of silver and tin (II) ions and can thus be discharged to the drains without further treatment.

In an especially preferred embodiment of the present invention, when the process comprises a step g) of nanofiltration of the washing water collected from the various washing baths used in the treatment method, as described in European Patent Application EP-A-1,132,771 of the same applicant, the nanofiltration unit is equipped with a nanofiltration membrane capable of retaining the organic and inorganic contaminants contained in the various washing baths, such as developers and co-developers, tin (II), iron, silver, thiocyanate, sulfate and thiosulfate ions. Nanofiltration membranes can be inorganic or organic. Organic membranes are membranes based on cellulose acetate, poly(amide/imide), polysulfone, acrylic polymers or fluoropolymers. Inorganic membranes are membranes based on carbon, ceramics, anodized aluminum, sintered metal or porous glass, or even made of woven composites based on carbon fibers. Nanofiltration membranes useful in the present invention have a wetting angle between 30° and 90°, preferably between 35° and 77° and a cut-off threshold between 100 and 1000 daltons, and preferably from 150 to 500 daltons. Preferably, the applied pressure varies between 5 and 4 MPa and preferably from 1 to 2 MPa.

Nanofiltration membranes that can be used in the present invention are the NF45 FILMTEC® membrane and the NF70 PILMTEC® membrane marketed by Dow Europe Separation Systems®, or the Osmonics DK® membrane, the Osmonics MX® membrane and the Osmonics SV® membrane marketed by the Osmonics company.

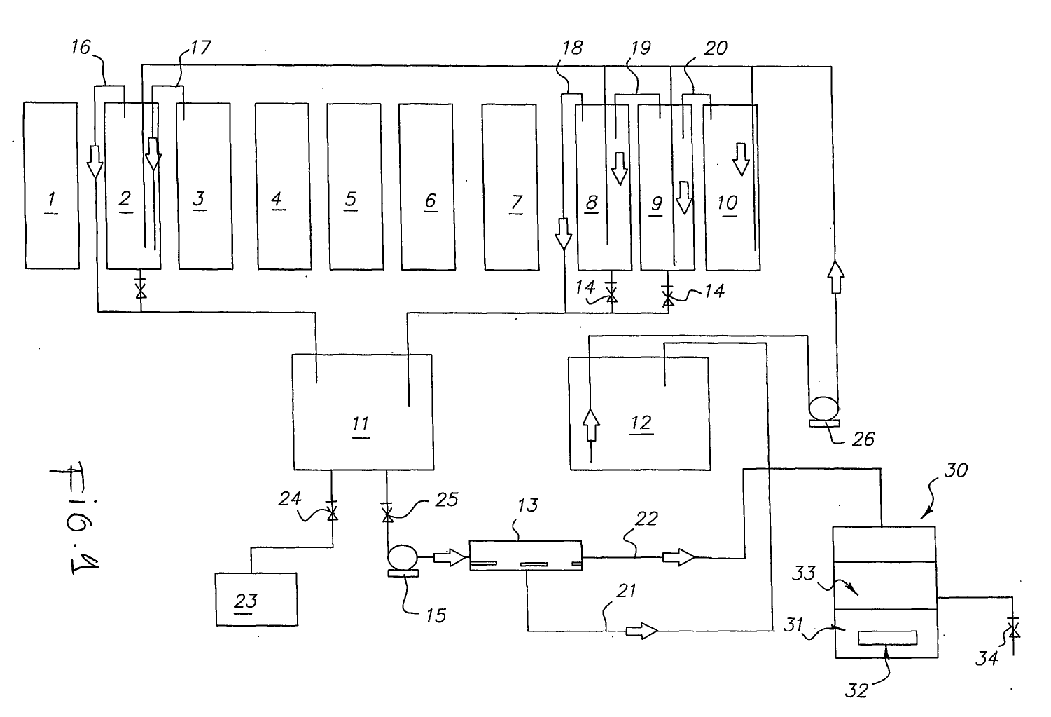

According to the method described in European Patent Application EP-A-1,132,771 and with reference to FIG. 1, the film to be developed is conveyed to a black and white development bath (1) on leaving which the film passes into a first washing bath (2), initially filled with clean water and whose water level is maintained by a counter-current (17) coming from the reversal bath (3). In order to prevent an overflow from the tank of the first washing bath and enable the recycling of its wastewater, an overflow device (16) enables the wastewater to be discharged to a buffer reservoir (11).

The film is then conveyed to the reversal bath (3), containing tin (II). The film then passes successively into a color development bath (4), a conditioning bath (5), a bleaching bath (6), a fixing bath (7), a final washing zone composed of baths (8) and (9), and finally a rinsing bath (10). Counter-currents (19) and (20) maintain the levels of the washing baths (8) and (9) respectively. Clean water may be added to the baths (2), (8), (9) and (10) coming from an auxiliary source (12) via a pump (26). The wastewater from the washing baths (2), (8) and (9) may be discharged to the buffer reservoir (11), either via overflows (16) and (18), or via emptying valves (14).

From the buffer reservoir (11), the wastewater is conveyed through a nanofiltration unit (13) with a membrane by opening the valve (25) and using a high-pressure pump (15). The permeate (21) from said nanofiltration unit (13) is very weakly charged with organic and inorganic compounds and can directly supply clean water either to an auxiliary source (12) (option shown on the diagram), or the final washing zone (option not shown on the diagram), or the first washing bath (option not shown on the diagram) or the rinsing bath (10) (option not shown on the diagram). This auxiliary source (12) may also be fed with clean water by a source external to the device (option not shown on the diagram). The auxiliary source (12) can be used either to replenish the washing baths (2), (8) and (9) after they have been emptied and circulated through the nanofiltration unit, or to supply water to the baths (2), (8), (9) and/or (10). Recycling the washing water from the permeate (21) substantially reduces water consumption (160 ml/m² instead of 120 l/m²).

Parts (not shown) can be added, such as, for example, conductimetry measuring devices for measuring the concentration of the solution in the buffer reservoir (11), with servo control enabling discharge of part of its contents when this concentration reaches or exceeds a certain limit, to be treated through an auxiliary treatment device (23). For example, a valve (24) can be provided to enable this discharge. One can also provide pH-meters to enable the adjustment of the pH to a required level.

The retentate (22) coming from the nanofiltration unit (13) is discharged from the circuit to a vessel (30) containing the composite material (31) comprising the imogolite onto which are grafted the sulfur functions. Water from the regular washing of the nanofiltration membrane is also collected and discharged into the vessel (30) and mixed with the retentate to produce an “ultimate” effluent. This ultimate effluent has a volume of about three liters a day. The vessel (30) is fitted with a suitable magnetic stirrer (32), rotating at a speed preferably between 300 and 800 rotations per minute. Stirring can also be carried out using a submerged pump with a flow rate preferably from 0.5 to 1 liter per minute. Stirring is maintained for a period of 1 to 4 hours, and preferably from 2 to 3 hours. Then the mixture is left to settle. A supernatant (33) forms that is discharged directly to the drains using a valve (34 ). The composite material (31) that is deposited at the bottom of the vessel (30) is recovered when its efficiency has reduced, especially when the sulfur sites are saturated with the silver ions. The composite material thus traps up to 50 g silver per kilogram of material, and up to 8 g tin per kilogram of material.

The silver and tin contained in this composite material can then be easily recovered by calcination of the composite material. The stirring was maintained for sufficient time so that the supernatant recovered contains silver and tin (II) ions in a quantity less than the maximum quantities required by the regulations on discharges to the drains. Therefore, no effluent remains to be treated.

The following examples illustrate the present invention in detail.

### 1) Preparation of the Composite Material

The composite material used in the present invention was prepared according to the method described in the U.S. Pat. No. 6,179,898.

16.7 mmoles of tetraethylorthosilicate Si(OR)₄ were added to 1000 ml deionized water. The reaction mixture was stirred at ambient temperature for one hour; then, this solution was added to 31.2 mmoles of AlCl₃,6H₂O in solution in 1000 ml pure water. The mixture was stirred for 20 minutes, then the pH was adjusted to 4.5 with NAOH,1M. The solution clouded. When the solution became transparent again, NaOH,IM was added to obtain pH 6.8. A white gel was obtained that was centrifuged for 20 minutes at 2000 rpm. This gel was collected and was put into solution with 5 ml of mixture comprising HCl,1M and acetic acid, 2M. The volume was made up to 2 l with water. The solution contained 30 mmoles Al, 16.6 mmoles Si, 5 mmoles HCl and 10 mmoles acetic acid. This solution was kept at 5° C.

This solution was then diluted with deionized water to obtain a concentration in Al of 10 mmoles/l. The diluted solution was heated for 5 days at 96° C., then filtered through an ultrafiltration membrane with a separation power of 10 000 daltons (membrane manufactured by AMICON). A clear solution was obtained containing Al and Si in a ratio Al:Si of 1.8.

A solution of 3-mercaptopropyltrimethoxysilane in anhydrous methanol (10⁻³ mole in 2 ml methanol) containing some drops of NH₄OH was added to 20 ml imogolite prepared according to the above method and containing 2.5 g/l of (Al+Si). The solution gelled (pH>7) and hydrolyzed in time. During hydrolysis, the siloxane grafted onto the imogolite. In addition, an infrared spectrum of the material showed that the organic part was not affected by the grafting and thus remained available to trap silver.

### 2) Embodiment of the Invention Method

A Noritsu QSF-R410L-3 E6 minilab commercially available from the Noritsu Company was used, with a “washless” configuration, by which water consumption is reduced by removing the continuous water supply from the first washing bath and the final washing baths. In order to season the baths, ten exposed films a day were developed in this minilab (KODAK ELITECHROME 100® and KODAK EKTACHROME 100 Plus Professional®, five rolls of each film a day for three days) using the Ektachrome E-6® process. The minilab used the following sequence.

| | | | Maintenance |
|---|---|---|---|
| E-6 baths | Time | Temperature ° C. | rate |
| First black and white | 6 min | 38 | 2150 ml/m² |
| development | | | |
| First washing bath | 2 min 30 sec | 30-35 | 0 ml/m² |
| Reversal bath with | 2 min 30 sec | 38 | 1075 ml/m² |
| counter-current in | | | |
| first washing | | | |
| bath | | | |
| Color development | 6 min | 38 | 2150 ml/m² |
| Conditioning bath | 2 min 30 sec | 38 | 1075 ml/m² |
| Bleaching | 6 min | 40 | 230 ml/m² |
| Fixing | 2 min 30 sec | 38 | 1075 ml/m² |
| Final washing | 2 min 30 sec | 30-35 | counter-current |
| Final washing | 2 min 30 sec | 30-35 | counter-current |
| Rinsing | 2 min 30 sec | 30-34 | 2150 ml/m² |

The experiment being carried out in “washless” conditions, the first washing bath was not fed with water. At the start, the water used in the first wash bath was replaced by nanofiltered fresh water. A counter-current from the reversal bath maintained the water level of the first washing bath. The sequence ended conventionally with a drying operation (temperature >67° C.).

The wastewater of the various washing baths was collected and circulated to a nanofiltration unit equipped with an NF45 FILMTEC® membrane having a specific treatment surface area of 2.21 m², commercially available from Dow Europe Separation Systems®, and operating at a pressure of 1 MPa. The water recovered in the permeate was reinjected into the various washing baths. The retentate was recovered and mixed with the water from the regular washing of the membrane of the nanofiltration unit to produce the ultimate effluent. 3.2 liters of this ultimate effluent were sampled.

At the start the ultimate effluent had chemical oxygen demand (COD) of 1538 ppm and total organic carbon (TOC) of 476 ppm. Total organic carbon (TOC) was measured according to AFNOR standard NF T90-102 June 1985; chemical oxygen demand (COD) was measured according to AFNOR standard NF T90-101. The COD and TOC values complied with the regulations on waste that require in particular CODs less than 2 g/l. However, at the start the ultimate effluent had a concentration in ionic silver greater than 1 ppm and a concentration in tin (II) greater than 100 ppm. Such concentrations are not acceptable for direct discharge to the drains, the maximum permitted concentration in silver ions being 1 ppm.

According to the invention, 1000 g of composite material prepared according to the method described in 1) were introduced into a 5-liter vessel. 3.2 liters of ultimate effluent were added and the mixture was maintained with stirring using a magnetic stirrer rotating at 500 rpm. At various times in the treatment, agitation was stopped, and the mixture of ultimate effluent/composite material was left to settle to form a supernatant. At each stop a sample of the supernatant was taken, which was filtered using a Millex-HV® filtration unit equipped with a Durapore® membrane with porosity 0.45 μm, commercially available from Millipore. The sample was then analyzed by inductively-coupled plasma-atomic emission spectroscopy (ICP) to determine the concentrations in silver, tin (II) and iron ions. The results are given below in Table I.

TABLE I
Reduction rate in dynamic mode

| Time (hours) | Ag (ppm) | Sn (ppm) | Fe (ppm) |
|---|---|---|---|
| 0 | 1.10 | 121 | 6 |
| 0.25 | 0.10 | 50 | 6 |
| 0.5 | 0.08 | 43 | 5 |
| 1 | 0.05 | 36 | 5 |
| 2 | 0.04 | 31 | 5 |
| 3 | 0.03 | 27 | 5 |
| 72 | 0.02 | 23 | 6 |
| Reduction % | 98.00 | 81.00 | 0.00 |

For comparison, the composite material was implemented according to the method and treatment device described in U.S. Pat. No. 6,179,898. Therefore, 750 g of the composite material were placed in a porous polyester bag, and the bag was placed in a drawer of the treatment device in which the effluents to be treated were circulated in closed circuit using a pump. 3.2 liters of ultimate effluent (retentate and washing water of the nanofiltration membrane) were passed through the treatment device with a flow rate of 9 l/min. At various times of the treatment, a sample leaving the treatment device was taken. The sample was then analyzed by ICP to determine the concentrations in ions of silver, tin (II) and iron as above. The results are given below in Table II.

TABLE II
Reduction rate in static mode

| Time (hours) | Ag (ppm) | Sn (ppm) | Fe (ppm) |
|---|---|---|---|
| 0 | 3.9 | 106 | 6.4 |
| 1 | 2.6 | 104 | 6.2 |
| 2 | 2.9 | 104 | 6.2 |
| 3 | 2.6 | 102 | 6.1 |
| 4 | 2.2 | 102 | 6.1 |
| 5 | 2.4 | 102 | 6.1 |
| 6 | 3 | 100 | 6.1 |
| 7 | 2.6 | 102 | 6.1 |
| 8 | 2.9 | 101 | 6.1 |
| 24 | 2 | 97 | 5.9 |
| Reduction % | 49 | 8 | 8 |

Table II shows that in static mode, the composite material of imogolite with sulfur functions has high retention selectivity for ionic silver compared with tin or iron. This is well in line with the teachings of U.S. Pat. No. 6,179,898 that describes the use of this composite material to trap efficiently the silver ions present in a washing bath. The silver ion reduction rate is 49% after 24 hours in static mode. However, the reduction rate for tin (II) is low (8%) for an equivalent duration. Such an effluent cannot be discharged as it is to the drains. Table I shows that in dynamic mode in accordance with the present invention, on the one hand, the reduction rate for ionic silver was improved as against a static treatment mode, this rate having reached 97% after only 3 hours of treatment. On the other hand, the dynamic mode treatment also significantly reduced the quantity of tin (II) ions present in the supernatant, the reduction rate for tin (II) being near 78% after only 3 hours treatment instead of 8% in static mode. Thus, the dynamic mode treatment using a composite material of imogolite having sulfur functions improves the reduction rate in ionic silver and no longer has retention selectivity between the silver and tin (II) ions as against a static treatment. Thus, the supernatant from the ultimate effluent contained greatly reduced quantities of silver and tin (II) ions enabling it to satisfy the regulations and be discharged to the drains. Thus there are no other effluents to be treated. The dynamic mode treatment using a composite material of imogolite grafted with sulfur functions combined with the nanofiltration treatment allows to achieve an ecological color reversal processing method, with no discharge of washing water that does not satisfy the regulations.

### 3) Evaluation of the Silver Ion Trapping Capacity of the Composite Material

After the embodiment of the invention method in paragraph 2) above, the supernatant was removed and a sample was recovered of 10 g of the composite material of imogolite with sulfur functions used in the treatment of the ultimate effluent. Said sample was placed in contact with 250 ml of silver nitrate solution at 6 g/l, with stirring (500 rpm) at ambient temperature.

At various times, stirring was stopped, and the mixture left to settle to form a supernatant. At each stop a sample of the supernatant was taken, which was filtered using a Millex-HV® (Millipore) filtration unit equipped with a Durapore® membrane with porosity of 0.45 μm. The sample was then analyzed by inductively-coupled plasma-atomic emission spectroscopy (ICP) to determine the concentration in silver ions remaining in the supernatant and thus derive the quantity of silver trapped by the composite material over time.

For the control, the same experiment was repeated, but with a sample of 10 g of the composite material with sulfur functions as obtained in 1), i.e. without having been put into contact with the tin (II) ions.

The results are given below in Table III.

TABLE III
Change of the silver-ion trapping capacity of the composite material
with sulfur functions

| | Quantity of silver ions trapped for 10 g of composite | |
|---|---|---|
| | material (g) | |
| | Composite material without | Composite material with prior |
| Time | prior contact with tin (II) ions | contact with tin (II) ions |
| (hours) | (Control) | (Invention) |
| 0 | 0 | 0 |
| 3 | 0.26 | 1 |
| 24 | 0.32 | 1.42 |
| 96 | 0.38 | 1.43 |
| 120 | 0.42 | 1.44 |
| 264 | 0.43 | 1.44 |

Table III clearly shows that the composite material of imogolite gel with sulfur functions, which was placed in contact with tin (II) ions from the reversal bath through the first washing bath, traps many more silver ions than a composite material of imogolite gel with sulfur functions that was not placed in contact with tin (II) ions. When the composite material is saturated and has lost its efficiency, it is recovered and calcinated to recover the metal species such as silver and tin.

1. A method for processing an exposed color reversal photographic film comprising the steps of circulating the exposed film successively in:
i) a black and white development bath,
ii) a first washing bath containing silver in ionic form,
iii) a reversal bath comprising tin (II) salts,
wherein the level of water in the first washing bath is maintained by a counter-current from the reversal bath, a volume of water at least equal to that provided by the counter-current being discharged through an overflow,
said method comprising the following steps:
a) collect the water from said overflow and the contents of said first washing bath, said water comprising silver and tin (II) ions,
b) put the collected water in a vessel equipped with stirring means and containing a composite material comprising a polymer matrix in the form of an imogolite gel in fiber from comprising at least on the fiber surface an organic radical having a function —SH or a radical —S(—CH2)ₙ—S— with n between 0 and 4,
c) stir said composite material and the collected water to let them mix,
d) leave said mixture to settle in order to obtain a supernatant,
e) recover said supernatant.

2. The method of claim 1, further comprising the circulation of the film in at least one final washing bath, and further comprising a step f) consisting in collecting the contents of said final washing bath and mixing it, before step (b), with the water from said overflow and the contents of said first washing bath collected in step (a).

3. The method of claims 1 or 2, further comprising a step g) carried out before step b), said step g) consisting in circulating the water collected in step (a) and/or step (f) through a nanofiltration unit to give on the one hand a permeate which can be used photographically on the one hand, and a retentate on the other hand, said retentate being collected and used to carry out step (b).

4. The method of claim 3, wherein, when the nanofiltration membrane used in the nanofiltration unit is washed, the water from washing the membrane is collected and added to the washing water collected in step a) and/or in step f).
